(19) United States
(12) Patent Application Publication
(10) Pub. No.: US 2014/0084218 A1
(43) Pub. Date: Mar. 27, 2014

(54) CONDUCTIVE COATINGS FOR CAPACITORS AND CAPACITORS EMPLOYING THE SAME

(71) Applicants: Changjing Chen, Shanghai (CN); Minghai Wang, Shanghai (CN)

(72) Inventors: Changjing Chen, Shanghai (CN); Minghai Wang, Shanghai (CN)

(21) Appl. No.: 13/974,403

(22) Filed: Aug. 23, 2013

Related U.S. Application Data
(63) Continuation of application No. PCT/CN2012/073137, filed on Mar. 27, 2012.

(30) Foreign Application Priority Data
Feb. 23, 2011 (CN) 201110043156.4

(51) Int. Cl. H01G 4/005

(52) U.S. Cl. CPC H01G 4/005
USPC 252/503; 252/514

(57) ABSTRACT

The present invention provides a novel conductive coating for capacitors, and a capacitor employing the conductive coating. The conductive coating of the present invention includes two types of coatings, i.e. thermosetting conductive coatings and thermoplastic conductive coatings. The thermosetting conductive coating of the present invention includes an epoxy resin, a curing agent for the epoxy resin, nonmetallic silver-plated particles and a solvent. The thermoplastic conductive coating of the present invention includes a thermoplastic resin, nonmetallic silver-plated particles and a solvent; wherein the thermoplastic resin is a fluorine rubber.

### FIELD OF INVENTION

The present invention relates to conductive coatings for capacitors, and capacitors employing the same.

### BACKGROUND TECHNOLOGY

At present, capacitors at the mainstream market are aluminium electrolytic capacitors, tantalum electrolytic capacitors, and ceramic capacitors etc. However, these capacitors suffer from the common problem that large energy losses are caused by the Equivalent Series Resistance (abbreviated as ESR).

When the ESR is lower, energy loss becomes smaller and the output current becomes larger, and the quality of the capacitor in turn is improved. The following advantages especially accompany a reduced ESR: (1) directly reducing noises coming from the parasitic resistance elements in the capacitor; and (2) rendering the nominal capacity of the capacitor appropriate under higher frequency conditions.

With an increased demand for high quality electronic elements, capacitors with low ESR represent the current development trend for capacitors. Accordingly, it is an ongoing effort to efficiently reduce the ESR of capacitors.

It is known that the ESRs of capacitors can be reduced efficiently by applying a conductive coating to the surfaces of capacitor elements. For example, the ESR of a capacitor can be reduced from 80 to about 0.1Ω by applying a conductive coating on its surface.

Regarding the conductive coatings, commercially available conductive coatings for capacitor mainly include conductive coatings comprising silver powders.

Conductive coatings comprising silver powders (referred to as silver pastes) are capable of lowering the ESRs of electrolytic capacitors. However, the silver pastes are expensive and therefore are not competitive due to high costs.

Silver-plated copper fillers can be used to reduce the costs of conductive coatings, but the surfaces of the copper powders is not completely covered with silver due to the limitations of the plating processes. The exposed copper is chemically active and can easily be oxidized, which leads to a drastic deterioration of the electrical and thermal conductivites and restricts its actual application.

In technical fields other than capacitors, there are reports concerning nonmetallic silver-plated fillers. For example, CN1144847C discloses a coating for electromagnetic shielding applications, comprising 10 to 50 wt % of nonmetallic silver-plated powders, 5 to 20 wt % of thermoplastic acrylic resin and 30 to 85 wt % of X-5 acrylic diluent. The coating forms a conductive layer on the surfaces of materials which have no or have little electromagnetic shield capability, so as to impart as good electromagnetic shield capability to the materials as that of an integral metal assembly.

CN101029212A discloses an anisotropic conductive adhesive based on epoxy resins, comprising 70 to 90 wt % of an epoxy resin, 8 to 12 wt % of a conductive material, 2 to 5 wt % of a curing agent, 2 to 10 wt % of a solvent and other additives, wherein the conductive material is silver-encapsulated glass, microspheres or ceramic microspheres. This conductive adhesive is used to bond electrical elements.

For example, in “preparation of an epoxy conductive anticorrosive coating in the electrolytic industry” (Electroplating and finishing”, Vol. 27, No. 12, pp. 49, 2008), a conductive coating, comprising 30 wt % of a modified epoxy resin, 70 wt % of silver-plated glass microbeads and a mixed solvent of n-butyl alcohol/xylene is disclosed. This conductive coating is used for the protection of conductive metal substrates, especially for the protection of conductive rods commonly used in the electrolytic processes against corrosion when used in humid and acid environments.

However, no reference has reported capacitors employing nonmetallic silver-plated fillers so far. Even if both fillers used in capacitors and those used in the above-mentioned applications are conductive coatings in the same electrical industries, their formulations and preparing methods differ widely from each other due to different application environments.

Initial conductivity and hot-wet stability are critical properties of the conductive coating for capacitors. The viscosity of the conductive coating is another important property, which directly influences the application conditions and coating thickness. None of the conductive coatings in the prior art is suitable for capacitors.

Therefore, it is necessary to develop a conductive coating for capacitors, which possesses an excellent initial conductivity and hot-wet stability, exhibits an appropriate viscosity and is cost effective.

### SUMMARY OF THE INVENTION

In view of the problems existing in the prior art, the present invention provides a novel conductive coating for capacitors.

According to one aspect of the present invention, a conductive coating for capacitors is provided which comprises: 5 to 30 wt % of an epoxy resin; 0.5 to 5 wt % of a curing agent for the epoxy resin; 20 to 50 wt % of nonmetallic silver-plated particles; and 40 to 70 wt % of a solvent.

The present invention also provides a condensate of the aforementioned conductive coating, wherein the solvent content of the condensate is less than the solvent content of said conductive coating.

According to another aspect of the present invention, a conductive coating for capacitors is provided which comprises: 3 to 20 wt % of a thermoplastic resin; 20 to 50 wt % of nonmetallic silver-plated particles; and 40 to 70 wt % of a solvent; wherein the thermoplastic resin is a fluorine rubber.

The present invention also provides a condensate of the above-mentioned conductive coatings, wherein the solvent content of the condensate is less than the solvent content of the conductive coating.

In the context of the present invention, the nonmetallic material in the nonmetallic silver-plated particles may be one or more selected from of glass, boron nitride, calcium carbonate, carbon black, carbon fiber, alumina and polymer materials.

The coating layers formed from the conductive coating according to the present invention not only possess excellent conductive properties, but also show high stabilities in hot-wet environments. The conductive coatings of the present invention also bring easy-to-make, ready-to-use, and cost effective benefits.

The present invention also provides a capacitor wherein at least one part of the surface of the capacitor is coated with a conductive coating layer, wherein the conductive coating layer is formed by applying the conductive coating according to the present invention to the surface of the capacitor, followed by curing and/or drying the conductive coating.

Many other features, aspects and advantages of the present invention will become apparent from the following description, Examples and accompanying claims.

### EMBODIMENT

Throughout this disclosure, all the scientific and technical terms, unless otherwise indicated, shall have the same meanings as those known to a person skilled in the art. Where there is inconsistency, the definition provided in the present invention should be taken.

Unless otherwise specified, all the percentages, parts, and ratios in this context are on the basis of weight.

All the materials, methods and examples are presented for the purposes of illustration, and therefore, unless expressly specified otherwise, are not construed as limitations of the present invention.

The present invention is described in detail as follows.

In the description and/or claims of the present invention, the term “capacitor” represents an electrical charge and energy storage device consisting of a pair of electrodes and dielectric materials therebetween. The capacitor, also referred to as capacitator, is a main element of sub-electrical circuits, which is common used in various fields such as direct current blocking, decoupling, bypass, filtering, tuned circuit, energy conversation, and control circuit.

An ideal capacitor itself does not lose any energy. However, energy losses are actually caused due to that the materials used to fabricate capacitor generally have electrical resistances and the resistances of the insulating dielectrics in the capacitor are never infinite which therefore lead to leakage currents. All these losses are exhibited out of the capacitor, which could be imagined as a series circuit containing a resistance and an ideal capacitor. As such, ESR is used to describe the resistance value of capacitor exhibited in the circuit.

In order to effectively reduce the ESR of the electrolytic capacitor with low cost, the present invention specifically provides a′novel conductive coating for capacitors.

A conductive coating may be divided into addition type coatings and structure type coatings in view of the conductivity mechanism. Conductive coatings of the addition type are prepared by adding conductive fillers to a non-conductive resin; while conductive coatings of the structure type per se are used as film-forming substances which utilize the conductivity of the structure type conductive polymer compound, or are employed in a mixture with other polymers to form a film. The conductive coatings of the addition type represent the mainstream type at present.

Thermosetting Conductive Coating

According to an embodiment of the present invention, a thermosetting conductive coating for capacitors is provided which comprises: 5 to 30 wt % of an epoxy resin; 0.5 to 5 wt % of a curing agent for the epoxy resin; 20 to 50 wt % of nonmetallic silver-plated particles; and 40 to 70 wt % of a solvent.

The thermosetting conductive coatings exhibit good adhesive properties, and require relatively high temperatures for curing.

In the context of the present invention, the term “epoxy resin” refers to a polymeric compound containing at least one epoxy group per molecule.

Epoxy resins suitable for use in the present invention include aromatic glycidyl epoxy resins or aliphatic epoxy resins, such as biphenol-based or novolac-based epoxy resins. Suitable examples include biphenol A based epoxy resins, biphenol S based epoxy resins, biphenol F based epoxy resins, phenolic-novolak based epoxy resins, and/or cresol-novolak based epoxy resin.

In the thermosetting conductive coatings according to the present invention, biphenol A based epoxy resins, such as Epikote 1007 which is available from Resolution Europe B.V., may be employed. Biphenol F based epoxy resins, such as 830CPR manufactured from Dainippon Ink & Chemical, JP, may also be employed.

The curing agent for the epoxy resins, also referred to as the hardener, is a substance or material which promotes or controls the curing reaction of the epoxy resins. The curing agent for the epoxy resins reacts with the epoxy resin to give polymers in steric network form. Curing agents suitable for use in the present invention include amine based or imidazole based curing agents, such as trihydroxyethyl amine.

The term “nonmetallic silver-plated particles” as used herein means structures where particles formed from nonmetallic materials are covered/coated by silver.

In principle, there are no specific limitations to the nonmetallic materials contained in the nonmetallic silver-plated particles according to the present invention, so long as these materials can be present in a stable state in the conductive coatings as well as in the working environments of the capacitors. For instance, one or more species selected from glass, boron nitride, calcium carbonate, carbon black, carbon fiber, alumina and polymer materials may be employed.

The surfaces of the nonmetallic particles are encapsulated by silver through conventional technical means, such as applying, and dipping.

The density of the nonmetallic silver-plated particles is preferably similar to the whole density of the conductive coating, so as to prohibit deterioration and failure of the coating which may be caused by the floatation or settlement of the particles. Nonmetallic silver-plated particles having a density of 3 to 5 g/cm³ are preferred.

The nonmetallic silver-plated particles preferably used in the present invention have an average particles size of 5 to 100 μm, more preferably of 10 to 40 μm, and most preferably of 10 to 20 μm.

As used herein, the term “average particle size” refers to the D50 value of the cumulative volume distribution curve at which 50% by volume of the particles have a diameter less than said value. The volume average particle size or D50 value is measured in the present invention through laser diffractometry, preferably using a Malvern Mastersizer 2000 available from Malvern Instruments Ltd. In this technique, the size of particles in suspensions or emulsions is measured using the diffraction of a laser beam, based on application of either Fraunhofer or Mie theory. In the present invention, Mie theory or a modified Mie theory for non-spherical particles is applied and the average particle sizes or D50 values relate to scattering measurements at an angle from 0.02 to 135 degrees relative to the incident laser beam. For the measurement it is further on preferred that a dispersion of the particles in a suitable liquid, such as acetone, is prepared by using ultrasonication. In order to produce an acceptable signal-to-noise ratio the particle concentration in the dispersion/suspension should preferably be chosen in a way that an obscuration in the range of 6% to 20% is obtained.

Generally speaking, a higher silver amount of the nonmetallic silver-plated particles is preferred, which in turn leads to high costs. Meanwhile, when the plated silver amount is too high, the nonmetallic silver-plated particles are proner to settle due to the too large density. Taking the various factors into consideration, the preferable amount of the plated silver in the nonmetallic silver-plated particles used in the present invention is 20 to 60 wt %, based on the total amount of the nonmetallic silver-plated particles. For silver-plated glass an amount of plated silver of 35 to 40 wt % is preferred, whereas an amount of plated silver of 45 to 55 wt % is preferred for silver-plated boron nitride, wherein each amount given is based on the total amount of the nonmetallic silver-plated particles.

In view of the compatibility with other components in the conductive coatings and the densities of the materials, silver-plated glass particles or silver-plated boron nitride particles are preferably employed in the conductive coatings of the present invention.

For example, the silver-plated boron nitride particles may be silver-plated boron nitride 30-103 which is available from Technic Inc.

Silver-plated glass particles are superior to silver-plated boron nitride particles in view of costs. However, undesirable metallic ions are usually introduced into the conductive coatings when employing silver-plated glass particles. Therefore, an ion exchanger is preferably incorporated into the conductive coating for applications which are sensitive to metallic ion impurities. A specific ion exchanger may be, for example, IXE 100 which is available from Toagosei Co., Ltd.

An ester based solvent and/or an ether based solvent is preferably employed in the present invention. More preferably ethylene glycol butyl ether acetate, dipropylene glycol monomethyl ether, ethylene glycol monobutyl ether or mixtures thereof are used in the present invention, wherein ethylene glycol butyl ether acetate is a particularly preferred solvent.

The epoxy resins account for 5 to 30 wt % of the conductive coatings of the present invention.

The content of the curing agent varies depending on various types of epoxy resins. In general, the amount of the curing agent for the epoxy resin is 0.5 to 5 wt %.

The content of the nonmetallic silver-plated particles is 20 to 50 wt %.

When selecting the solvent amount, both the stability and the viscosity of the conductive coating shall be taken into consideration. If the resin contained in the conductive coating is a thermosetting resin, the appropriate viscosity (25° C.) of the coating ranges from 400 mPa·s to 800 mPa·s. Correspondingly, the solvent amount in the thermosetting conductive of the present invention is 40 to 70 wt %.

The contents or amounts of the components described above relate to the total amount of the conductive coating of the present invention.

Coating condensates (or semi-final products of coatings) are commonly commercially available. The difference between the coating condensates and the conductive coatings is their solvent content. Compared with the final products of the conductive coatings, coating condensates have greatly decreased solvent contents. These coating condensates are another aspect of the present invention.

When preparing the condensates, the control of the initial viscosity is critical. Theoretically, any product with a viscosity below 100000 cps (5 rpm) may be employed as the coating condensate according to the present invention. The coating condensates are diluted appropriately to prepare a suitable coating composition of the present invention. The thermoplastic conductive coating and the thermosetting conductive coating have different requirements to viscosities, and the viscosities also vary depending on the requirements of clients. The viscosity of the condensate generally varies from 3000 to 30000 cps, preferably from 5000 to 10000 cps.

Corresponding to the above-mentioned viscosity ranges, the content of each component contained in the condensates of the thermosetting conductive coatings according to the present invention, for example, may be 5 to 40 wt % of an epoxy resin, 0.5 to 7.5 wt % of a curing agent for the epoxy resin, 25 to 65 wt % of nonmetallic silver-plated particles and 10 to 40 wt % of a solvent.

In addition to the above-mentioned main components, other additives may be added to the coating composition of the present invention, such as adhesion promoters, dispersants, defoamers, and thixotropic adjusters. Siloxane based adhesion promoters terminated with active functional groups may be used as adhesion promoters, e.g. Silane A-187, Z-6040, etc. Organic silicon dispersants may be employed as dispersants, such as BYK W940 and BYK-333. Organic silicon dispersants may be employed as defoamers, such as Modaflow and Modaflow 2000 available from Cytec Surface Specialties Inc. Gas phase silicon dioxide may be used as thixotropic adjusters, such as TS720 and R202.

The conductive coating of the present invention may be manufactured according to those methods well-known to a person skilled in the art. For example, the followings steps may be employed to produce the thermosetting conductive coating of the present invention: firstly, a solvent accounting for 40 to 60% of the total solvent amount is added to the epoxy resin under stirring to completely dissolve the resin; Secondly, nonmetallic silver-plated particles are added to the solution, and the solution is stirred for 0.5 to 30 minutes; and finally, the missing quantity of solvents is added, and the solution is stirred for additional 0.5 to 30 minutes to obtain the conductive coating. The stirrer used herein is preferably a mechanical stirrer, with a rotational speed of 500 to 1500 rpm.

The thermosetting conductive coating according to the present invention can be applied to the surface of a substrate by conventional coating methods, such as dip coating and spray coating. After being applied to the surface of a substrate, the conductive coating is dried and/or curedat an appropriate temperature.

The conditions for drying and/or curing the thermosetting conductive coatings may be set as follows: maintaining a constant temperature of 60 to 150° C. for 10 to 120 minutes, and then maintaining a constant temperature of 160 to 250° C. for 10 to 120 minutes; typically maintaining a constant temperature of 80° C. for 30 minutes, and then elevating the temperature to 200° C. and keeping the temperature constant for half an hour.

Thermoplastic Conductive Coating

Another aspect of the present invention is a thermoplastic conductive coating which comprises: 3 to 20 wt % of a thermoplastic resin; 20 to 50 wt % of nonmetallic silver-plated particles; and 40 to 70 wt % of a solvent; wherein the thermoplastic resin is a fluorine rubber.

The temperature for curing the thermoplastic conductive coating is low, and therefore the thermoplastic conductive coating is suitable for applications which have strict requirements for curing temperatures and less strict requirements as to adhesive properties. At present, the curing temperatures of many conductive coatings need to be lower than 150° C., and thus the thermoplastic system is superior to the thermosetting system in this regard.

In the context of the present invention, the term “thermoplastic resin” means resins that exist in plastic states when heated or melted and harden again when cooled. Suitable fluorine rubbers include fluorine rubber elastomers and block copolymers of fluoroethylene monomers. Examples of suitable fluorine rubbers include FC 2178 or FC 2017 which are commercially available from Dyneon.

It is to be understood that the definitions and embodiments for the nonmetallic silver-plated particles of the thermosetting conductive coatings apply mutatis mutandis to the nonmetallic silver-plated particles of the thermoplastic conductive coatings.

There are no specific limitations to the solvent used in the thermoplastic conductive coatings of the present invention, wherein the preferred embodiments of the solvents for the thermosetting conductive coatings apply mutatis mutandis to the solvents of the thermoplastic conductive coatings.

The content of the thermoplastic resin in the thermoplastic conductive coatings according to the present invention is 3 to 20 wt %.

The amount of the nonmetallic silver-plated particles used in the thermoplastic conductive coating according to the present invention is 20 to 50 wt %.

As mentioned above, when determining the solvent amount, both the stability and the viscosity of the conductive coating shall be taken into consideration. If the resin of the conductive coating is a thermoplastic resin, the appropriate viscosity (25° C.) of the coating ranges from 1000 mPa·s to 2000 mPa·s. Correspondingly, the preferable solvent amount in the thermoplastic conductive coatings of the present invention is 40 to 70 wt %.

The contents or amounts of the components described above relate to the total amount of the thermoplastic conductive coating of the present invention.

Theoretically, any product with a viscosity below 100000 cps (5 rpm) may be employed as the coating condensate according to the present invention. The coating condensate has to be diluted appropriately to prepare a suitable coating composition of the present invention.

The viscosity of the coating condensate is usually about 10000 cps.

Corresponding to the above-mentioned viscosity ranges, the content of each component contained in the condensates of the thermoplastic conductive coatings according to the present invention, for example, may be 10 to 25 wt % of a thermoplastic resin, 40 to 65 wt % of nonmetallic silver-plated particles and 10 to 40 wt % of a solvent.

In addition to the above-mentioned main components, other additives may be added to the thermoplastic conductive coating compositions of the present invention, such as adhesion promoters, dispersants, defoamers, and thixotropic adjusters. Siloxane based adhesion promoters terminated with active functional groups may be used as adhesion promoter, e.g. Silane A-187, Z-6040, etc. Organic silicon dispersants may be employed as dispersants, such as BYK W940 and BYK-333. Acrylates may be employed as defoamers, such as Modaflow and Modaflow 2000 available from Cytec Surface Specialties Inc. Gas phase silicon dioxide may be used as thixotropic adjuster, such as TS720 and R202.

The thermoplastic conductive coating of the present invention may be manufactured according to those methods well-known to a person skilled in the art. For example, the followings steps may be employed to produce the thermoplastic conductive coating according to the present invention: firstly, a solvent accounting for 50 to 80% of the total solvent amount is added to the thermoplastic resin under stirring to completely dissolve the resin; secondly, nonmetallic silver-plated fillers are added to the solution and the solution is stirred for 0.5 to 30 minutes; and finally, the missing quantity of solvents is added, and the solution is stirred for additional 0.5 to 30 minutes, to obtain the conductive coating. The stirrer used herein is preferably a mechanical stirrer, with a rotational speed of 500 to 1500 rpm.

The thermoplastic conductive coating according to the present invention can be applied to the surface of a substrate by conventional coating methods, such as dip coating and spray coating. After being applied to the surface of a substrate, the conductive coating is dried and/or cured at an appropriate temperature.

The conditions for drying and/or curing the thermoplastic conductive coatings may be set as follows: maintaining a constant temperature of 80 to 200° C. for 10 to 120 minutes, typically maintaining a constant temperature of 150° C. for 60 minutes.

The volume resistivity of the nonmetallic silver-plated particles according to the present invention is close to that of silver powders. Since nonmetallic silver-plated particles of present invention only have a silver coating deposited on the surfaces of said particles, the present invention greatly reduce costs compared to conventional silver powders. Furthermore, the density of the nonmetallic silver-plated particles of the present invention is similar to the overall density of the conductive coating, which avoids the settling of the particles, and thus the coatings have a longer shelf.

Capacitor

There are various types of capacitors, with ceramic capacitors, aluminium electrolytic capacitors, talc capacitor, paper dielectric capacitor, tantalum electrolytic capacitor, and film capacitor etc. being commonly used. Although different capacitors distinguish from each other in their structures, these capacitors share one common feature, i.e. having insulating materials (dielectrics) sandwiched between a pair of electrodes.

The conductive coatings according to the present invention can be useful for any capacitor which is to form a conductive coating layer therein, especially for capacitors having relatively strict requirements for stability in hot-wet environments. The conductive coatings according to the present invention are particularly suitable for aluminium electrolytic capacitors, tantalum electrolytic capacitors or niobium electrolytic capacitors.

Tantalum electrolytic capacitors for example comprise a sintered body obtained by pressing and sintering tantalum powders, a tantalum oxide film on the sintered body, a manganese dioxide layer and a conductive layer on the manganese dioxide. The conductive layer is used to promote the conductivity of the cathode, and thus to reduce the ESR of the whole circuit.

The conductive coatings according to the present invention may be used to form the conductive layer. The conductive layer made from the conductive coatings according to the present invention shows excellent initial conductivity and hot-wet stability. The conductive coatings according to the present invention have appropriate viscosities which make them compatible with the commonly used dip coating process.

### EXAMPLES

The present invention is described below in more detail by means of examples and specific data, wherein the examples and specific data serve solely to illustrate the modes to carry out the invention and advantageous effects thereof and do not represent any limitations of the inventive concept.

Materials

Epikote 1007: biphenol A based epoxy resin, available from Resolution Europe B.V.

jER 828US: biphenol A based epoxy resin, available from Japan Epoxy resins Co., Ltd.

Silane A-187: glycidoxypropyl trimethoxysilane, available from Momentive Performance Materials.

BYK W940: comprising unsaturated polycarbonate and organic silicon copolymer as main components, available from BYK USA Inc.

Modaflow: polymer of 2-ethyl acrylate and 2-ethylhexyl 2-acrylate, available from Cytec Surface Specialties Inc.

TS720: gas phase silicon dioxide, available from CABOT Corporation.

SG15F35: silver-plated glass sheet, 35 wt % of silver content, average particles size 15 μm, available from Potter Industries Inc.

SG05TF40: silver-plated glass sheet, 40 wt % of silver content, average particles size 5 μm, available from Potter Industries Inc.

30-103: silver-plated boron nitride sheet, 53 wt % of silver content, average particles size 12 μm, available from Technic Inc.

FC 2178: fluorine rubber (vinylidene fluoride-hexafluoropropylene copolymer), available from Dyneon.

Test Methods

A series of tests were carried out to demonstrate the advantageous effects of the conductive coatings, including conductivity tests, density tests, viscosity tests and hot-wet tests.

<Density Tests>

The resultant conductive coatings were subjected to density tests according to industry standard ATM-0001. The details are as follows:

The main instrument used in the tests was a densimeter.

The empty densimeter was weighed first, and then filled the densimeter with pure water and weighed again, so as to calculate the mass of the pure water ml. Subsequently, the water was removed from the densimeter and a coating sample under test was filled therein, so as to get the mass of the sample m2. Finally, the density of the coating sample was calculated by the equation D=m2/m1×1.0(g/cm³).

<Viscosity Tests>

The resultant conductive coatings were subjected to viscosity tests according to industry standard ATM-0216. The details are as follows:

Test instrument: AR-500 rheometer, 40 mm cone-and-plate rotator.

0.5 ml of coating product was weighed out and placed between the cone and plate, and then measured the viscosity at a rotation speed of 15 r/s.

The measuring temperature was always set at normal temperature, i.e. 25° C.

<Hot-Wet Tests>

The resultant conductive coating layers (after curing) were subjected to hot-wet tests in the following manner:

The samples under test were first placed into a thermostat at a relative humidity of 85% and a temperature of 85° C., and then took out the samples and measured the volume resistivities at intervals. The variation of the volume resistivities during a certain period could be measured by recording the several data, and thereby evaluating the hot-wet resistances of the samples.

<Volume Resistivity Tests>

The conductive coating layers after curing were subjected to conductivity tests according to industry standard ATM-0020. The details are as follows:

Test instrument: Gen Rad 1689 RLC precision digital bridge.

The samples under test were prepared on a cover glass by applying conductive coatings to form coating layers in rectangular shape (length: 7.5 cm; and width: 1.25 cm). The thickness varied depending on the samples and needed specific measurement. The thickness generally varied between 0.001 and 0.01 cm. The coating layer was cured, and then placed on the electric bridge to determine the resistance, and the volume resistivity was calculated according to the following equation:

ρ=0.254R/L

wherein ρ is volume resistivity, R is the measured value of the resistance, and L is the thickness of the sample.

### Example 1

26.5 g ethylene glycol butyl ether acetate was added to a mixture of 12.2 g epoxy resin Epikote 1007 (available from Resolution Europe B.V.), 2.6 g triethanolamine (available from Sinopharm Chemical Reagent Co., Ltd), 0.4 g Silane A-187 (adhesion promoter, available from Momentive Performance Materials), 0.6 g BYK W940 (dispersant, available from BYK USA Inc.) and 0.1 g Modaflow (defoamer, available from Cytec Surface Specialties Inc.) while mechanically stirring with Thinky Mixer.

Silver-plated glass particles SG15F35 (available from Potter Industries Inc., silver content 35 wt %, average particles size 15 μm) were added to the resultant solution and stirred to get a uniform solution, and then the solution was stirred by using a rotatory evaporator at a rotational speed of 1200 rpm for 1 minute.

21.8 g ethylene glycol butyl ether acetate was additionally incorporated and stirred by using a rotatory evaporator for 1.5 minutes, and the conductive coating was obtained thereby.

Two layers of tapes (thickness: about 0.005 cm) were attached to the same side of the cover glass, with a gap of 1.25 cm formed between the two tape layers, and an appropriate amount of the resultant conductive coating was weighed out and placed into the gap, flattened by doctor blade and peeled off the tape layers on the two edges to get a rectangular shaped coating layer, (length: about 7.5 cm, width: about 1.25 cm, and height: about 0.005 cm).

The coating layer was cured at the following temperatures: maintained at a constant temperature of 80° C. for 30 minutes, and then the temperature was elevated to 200° C. and kept for half an hour. The conductive coating layer sample was thus obtained.

The particular formulation of the conductive coating in Example 1 was as follows:

TABLE 1

| Components | Product numbers | Amounts (g) |
|---|---|---|
| Epoxy resin | Epikote 1007 | 12.2 |
| Curing agent | Triethanolamine | 2.6 |
| Adhesion promoter | Silane A-187 | 0.4 |
| Dispersant | BYK W940 | 0.6 |
| Defoamer | Modaflow | 0.1 |
| Thixotropic adjuster | TS720 | 2.4 |
| Solvent | Ethylene glycol butyl ether acetate | 48.3 |
| Nonmetallic | Silver-plated glass, SG15F35 | 33.4 |
| silver-plated particles | | |
| Total | | 100% |

### Example 2

The conductive coating and conductive coating layer were prepared in the same manner as described in Example 1, except employing the following coating formulation.

The particular formulation of the conductive coating in Example 2 was as follows:

TABLE 2

| Components | Product numbers | Amounts (g) |
|---|---|---|
| Epoxy resin | Epikote 1007 | 10.5 |
| Curing agent | Triethanolamine | 2.2 |
| Adhesion promoter | Silane A-187 | 0.3 |
| Dispersant | BYK W940 | 0.5 |
| Defoamer | Modaflow | 0.1 |
| Thixotropic adjuster | TS720 | 2.0 |
| Solvent | Ethylene glycol butyl ether acetate | 41.4 |
| Nonmetallic | Silver-plated glass, SG15F35 | 43.0 |
| silver-plated particles | | |
| Total | | 100% |

### Example 3

The conductive coating and conductive coating layer were prepared in the same manner as described in Example 1, except employing the following coating formulation.

The particular formulation of the conductive coating in Example 3 was as follows:

TABLE 3

| Components | Product numbers | Amounts (g) |
|---|---|---|
| Epoxy resin | jER 828US | 10.1 |
| Curing agent | Triethanolamine | 2.2 |
| Adhesion promoter | Silane A-187 | 0.3 |
| Dispersant | BYK W940 | 0.5 |
| Defoamer | Modaflow | 0.1 |
| Thixotropic adjuster | TS720 | 2.0 |
| Solvent | Ethylene glycol monobutyl ether | 42.4 |
| Nonmetallic | Silver-plated glass, SG15F35 | 42.4 |
| silver-plated particles | | |
| Total | | 100% |

### Example 4

The conductive coating and conductive coating layer were prepared in the same manner as described in Example 1, except employing the following coating formulation.

The particular formulation of the conductive coating in Example 4 was as follows:

TABLE 4

| | | Amounts |
|---|---|---|
| Components | Product numbers | (g) |
| Epoxy resin | jER 828US | 8.1 |
| Curing agent | Triethanolamine | 1.7 |
| Adhesion promoter | Silane A-187 | 0.3 |
| Dispersant | BYK W940 | 0.4 |
| Defoamer | Modaflow | 0.1 |
| Thixotropic adjuster | TS720 | 1.6 |
| Solvent | Ethylene glycol monobutyl ether | 45.0 |
| Nonmetallic | Silver-plated glass, SG05TF40 | 42.8 |
| silver-plated particlesr | | |
| Total | | 100% |

### Example 5

The conductive coating and conductive coating layer were prepared in the same manner as described in Example 1, except employing the following coating formulation.

The particular formulation of the conductive coating in Example 5 was as follows:

TABLE 5

| | | Amounts |
|---|---|---|
| Components | Product numbers | (g) |
| Epoxy resin | Epikote 1007 | 9.8 |
| Curing agent | Triethanolamine | 2.1 |
| Adhesion promoter | Silane A-187 | 0.3 |
| Dispersant | BYK W940 | 0.5 |
| Defoamer | Modaflow | 0.1 |
| Thixotropic adjuster | TS720 | 1.9 |
| Solvent | Ethylene glycol butyl ether acetate | 49.6 |
| Nonmetallic | Silver-plated boron nitride30-103 | 35.7 |
| silver-plated particles | | |
| Total | | 100 |

### Example 6

The conductive coating and conductive coating layer were prepared in the same manner as described in Example 1, except employing the following coating formulation.

The particular formulation of the conductive coating in Example 6 was as follows:

TABLE 6

| | | Amounts |
|---|---|---|
| Components | Product numbers | (g) |
| Epoxy resin | Epikote 1007 | 9.0 |
| Curing agent | Triethanolamine | 1.9 |
| Adhesion promoter | Silane A-187 | 0.3 |
| Dispersant | BYK W940 | 0.4 |
| Defoamer | Modaflow | 0.1 |
| Thixotropic adjuster | TS720 | 1.8 |
| Solvent | Ethylene glycol butyl ether acetate | 43.7 |
| Nonmetallic | Silver-plated boron nitride30-103 | 42.8 |
| silver-plated particles | | |
| Total | | 100 |

### Example 7

The conductive coating and conductive coating layer were prepared in the same manner as described in Example 1, except employing the following coating formulation.

The particular formulation of the conductive coating in Example 7 was as follows:

TABLE 7

| Components | Product numbers | Amounts (g) |
|---|---|---|
| Epoxy resin | jER 828US | 9.8 |
| Curing agent | Triethanolamine | 2.0 |
| Adhesion promoter | Silane A-187 | 0.3 |
| Dispersant | BYK W940 | 0.5 |
| Defoamer | Modaflow | 0.1 |
| Thixotropic adjuster | TS720 | 1.9 |
| Solvent | Ethylene glycol monobutyl ether | 44.3 |
| Nonmetallic | Silver-plated boron nitride30-103 | 41.1 |
| silver-plated particles | | |
| Total | | 100 |

### Example 8

The conductive coating and conductive coating layer were prepared in the same manner as described in Example 1, except employing the following coating formulation.

The particular formulation of the conductive coating in Example 8 was as follows:

TABLE 8

| | | Amounts |
|---|---|---|
| Components | Product numbers | (g) |
| Epoxy resin | jER 828US | 8.2 |
| Curing agent | Triethanolamine | 1.8 |
| Adhesion promoter | Silane A-187 | 0.3 |
| Dispersant | BYK W940 | 0.4 |
| Defoamer | Modaflow | 0.1 |
| Thixotropic adjuster | TS720 | 1.6 |
| Solvent | Ethylene glycol monobutyl ether | 44.6 |
| Nonmetallic | Silver-plated boron nitride30-103 | 43.0 |
| silver-plated particles | | |
| Total | | 100 |

### Example 9

40 g ethylene glycol butyl ether acetate was added to 8.2 g solid fluorine rubber FC 2178 (available from Dyneon), and stirred to dissolve the solid, and a fluorine rubber solution was thus obtained.

25.6 g silver-plated glass filler SG15F35 (available from Potter Industries Inc., silver content 35 wt %, average particles size 15 μm) was added to the resultant solution and stirred to get a uniform solution, and then the solution was stirred by using a rotatory evaporator at a rotational speed of 1200 rpm for 1 minute.

The remaining solvent was added and the resulting mixture was stirred by using a rotatory evaporator for 1 minute, and a thermoplastic conductive coating was obtained thereby.

Two layers of tapes (thickness: about 0.005 cm) were attached to the same side of the cover glass, with a gap of 1.25 cm formed between the two tape layers, and an appropriate amount of the resultant conductive coating was weighed out and placed into the gap, flattened by doctor blade and peeled off the tape layers on the two edges to get a rectangular shaped coating layer, (length: about 7.5 cm, width: about 1.25 cm, and height: about 0.005 cm).

The coating layer was cured at a constant temperature of 150° C. for 60 minutes, and the conductive coating layer sample was thus obtained.

The particular formulation of the conductive coating in Example 9 was as follows:

TABLE 9

| Component | Product numbers | Amounts (g) |
|---|---|---|
| Thermoplastic resin | Fluorine rubber FC 2178 | 8.2 |
| Solvent | Ethylene glycol butyl ether | 66.2 |
| | acetate | |
| Nonmetallic | Silver-plated glass, SG15F35 | 25.6 |
| silver-plated particles | | |
| Total | | 100 |

### Example 10

The conductive coating and conductive coating layer were prepared in the same manner as described in Example 9, except employing the following coating formulation.

The particular formulation of the conductive coating in Example 10 was as follows:

TABLE 10

| Component | Product numbers | Amounts (g) |
|---|---|---|
| Thermoplastic resin | Fluorine rubber FC-2178 | 6.1 |
| Solvent | Ethylene glycol butyl ether | 58.1 |
| | acetate | |
| Nonmetallic | Silver-plated glass, SG15F35 | 35.8 |
| silver-plated particles | | |
| Total | | 100 |

### Example 11

The conductive coating and conductive coating layer were prepared in the same manner as described in Example 9, except employing the following coating formulation.

The particular formulation of the conductive coating in Example 11 was as follows:

TABLE 11

| Component | Product numbers | Amounts (g) |
|---|---|---|
| Thermoplastic resin | Fluorine rubber FC-2178 | 6.1 |
| Solvent | Ethylene glycol butyl ether | 54.1 |
| | acetate | |
| Nonmetallic | Silver-plated glass, SG15F35 | 39.8 |
| silver-plated particles | | |
| Total | | 100 |

### Example 12

The conductive coating and conductive coating layer were prepared in the same manner as described in Example 9, except employing the following coating formulation.

The particular formulation of the conductive coating in Example 12 was as follows:

TABLE 12

| Component | Product numbers | Amounts (g) |
|---|---|---|
| Thermoplastic resin | Fluorine rubber FC-2178 | 5.3 |
| Solvent | Ethylene glycol butyl ether | 49.9 |
| | acetate | |
| Nonmetallic | Silver-plated glass, SG15F35 | 44.8 |
| silver-plated filler | | |
| Total | | 100 |

### Example 13

The conductive coating and conductive coating layer were prepared in the same manner as described in Example 9, except employing the following coating formulation.

The particular formulation of the conductive coating in Example 13 was as follows:

TABLE 13

| Component | Product numbers | Amounts (g) |
|---|---|---|
| Thermoplastic resin | Fluorine rubber FC-2178 | 6.2 |
| Solvent | Ethylene glycol butyl ether | 58.9 |
| | acetate | |
| Nonmetallic | Silver-plated glass, SG15F45 | 34.9 |
| silver-plated particles | | |
| Total | | 100 |

### Example 14

The conductive coating and conductive coating layer were prepared in the same manner as described in Example 9, except employing the following coating formulation.

The particular formulation of the conductive coating in Example 14 was as follows:

TABLE 14

| Component | Product numbers | Amounts (g) |
|---|---|---|
| Thermoplastic resin | Fluorine rubber FC 2178 | 8.2 |
| Solvent | Ethylene glycol butyl ether | 66.2 |
| | acetate | |
| Nonmetallic | Silver-plated boron nitride30-103 | 25.6 |
| silver-plated particles | | |
| Total | | 100 |

### Example 15

The conductive coating and conductive coating layer were prepared in the same manner as described in Example 9, except employing the following coating formulation.

The particular formulation of the conductive coating in Example 15 was as follows:

TABLE 15

| Component | Product numbers | Amounts (g) |
|---|---|---|
| Thermoplastic resin | Fluorine rubber FC 2178 | 6.1 |
| Solvent | Ethylene glycol butyl ether | 58.1 |
| | acetate | |
| Nonmetallic | Silver-plated boron nitride30-103 | 35.6 |
| silver-plated particles | | |
| Total | | 100 |

### Comparative Example 1

### Silver Powders were Used as Conductive Fillers

The conductive coating and conductive coating layer were prepared in the same manner as described in Example 9, except employing silver powders as conductive fillers.

The particular formulation of the conductive coating in Comparative Example 1 was as follows:

TABLE 16

| | | Amounts |
|---|---|---|
| Components | Product numbers | (g) |
| Epoxy resin | Epikote 1007 | 8.4 |
| Curing agent | Triethanolamine | 1.7 |
| Adhesion promoter | Silane A-187 | 0.3 |
| Defoamer | Modaflow | 0.1 |
| Thixotropic adjuster | TS720 | 1.9 |
| Solvent | Ethylene glycol butyl ether acetate | 44.4 |
| Silver powder | Ferro silver powder SF9H | 43.2 |
| Total | | 100% |

### Comparative Example 2

### Employing Silver-Plated Copper Powders as Conductive Fillers

The conductive coating and conductive coating layer were prepared in the same manner as described in Example 9, except employing silver-plated copper powders as conductive fillers.

The particular formulation of the conductive coating in Comparative Example 2 was as follows:

TABLE 17

| | | Amounts |
|---|---|---|
| Components | Product numbers | (g) |
| Epoxy resin | Epikote 1007 | 8.9 |
| Curing agent | Triethanolamine | 2.0 |
| Adhesion | Silane A-187 | 0.4 |
| promoter | | |
| Dispersant | BYK W940 | 0.5 |
| Defoamer | Modaflow | 0.1 |
| Thixotropic adjuster | TS720 | 2.2 |
| Solvent | Ethylene glycol butyl ether acetate | 38.2 |
| Silver-plated copper | Dowa silver-plated | 47.7 |
| powders | copperCG-SAB-121 | |
| Total | | 100% |

Effect Data

The conductive coatings obtained in Examples 1 to 15 were subjected to viscosity tests, density tests, and hot-wet tests. The test results are listed in Table 18 below.

TABLE 18

| | Test methods | | | |
|---|---|---|---|---|
| | Viscosity tests | Density tests | Hot-wet tests | |
| Examples | (cps) | (g/cm³) | (10⁻³Ω · cm⁻¹) | |
| Example 1 | 450 | 1.39 | initial | 2.31 |
| | | | value | |
| | | | after 1 day | 1.31 |
| | | | after 7 | 1.10 |
| | | | days | |
| | | | after 14 | 0.983 |
| | | | days | |
| | | | after 28 | 0.989 |
| | | | days | |
| | | | after 35 | 0.9 |
| | | | days | |
| | | | after 42 | 1.31 |
| | | | days | |
| Example 2 | 750 | 1.5 | initial | 0.998 |
| | | | value | |
| | | | after 1 day | 0.998 |
| | | | after 7 | 0.921 |
| | | | days | |
| | | | after 14 | 0.72 |
| | | | days | |
| | | | after 28 | 0.82 |
| | | | days | |
| | | | after 35 | 1.0 |
| | | | days | |
| | | | after 42 | 0.982 |
| | | | days | |
| Example 3 | 700 | 1.5 | initial | 3.25 |
| | | | value | |
| | | | after 1 day | 3.25 |
| | | | after 7 | 1.27 |
| | | | days | |
| | | | after 14 | 2.68 |
| | | | days | |
| | | | after 28 | 1.08 |
| | | | days | |
| | | | after 35 | 2.04 |
| | | | days | |
| | | | after 42 | 1.94 |
| | | | days | |
| Example 4 | 650 | 1.5 | initial | 4.5 |
| | | | value | |
| | | | after 1 day | 4.5 |
| | | | after 7 | 3.25 |
| | | | days | |
| | | | after 14 | 4.67 |
| | | | days | |
| | | | after 28 | 3.98 |
| | | | days | |
| | | | after 35 | 3.86 |
| | | | days | |
| | | | after 42 | 4.02 |
| | | | days | |
| Example 5 | 400 | 1.42 | initial | 0.912 |
| | | | value | |
| | | | after 1 day | 0.912 |
| | | | after 7 | 0.906 |
| | | | days | |
| | | | after 14 | 1.04 |
| | | | days | |
| | | | after 28 | 1.03 |
| | | | days | |
| | | | after 35 | 1.08 |
| | | | days | |
| | | | after 42 | 1.22 |
| | | | days | |
| Example 6 | 500 | 1.52 | initial | 1.22 |
| | | | value | |
| | | | after 1 day | 1.22 |
| | | | after 7 | 1.02 |
| | | | days | |
| | | | after 14 | 0.92 |
| | | | days | |
| | | | after 28 | 0.98 |
| | | | days | |
| | | | after 35 | 1.03 |
| | | | days | |
| | | | after 42 | 1.05 |
| | | | days | |
| Example 7 | 480 | 1.48 | initial | 2.28 |
| | | | value | |
| | | | after 1 day | 2.28 |
| | | | after 7 | 2.51 |
| | | | days | |
| | | | after 14 | 1.8 |
| | | | days | |
| | | | after 28 | 2.42 |
| | | | days | |
| | | | after 35 | 2.32 |
| | | | days | |
| | | | after 42 | 2.06 |
| | | | days | |
| Example 8 | 550 | 1.5 | initial | 0.8 |
| | | | value | |
| | | | after 1 day | 0.8 |
| | | | after 7 | 0.95 |
| | | | days | |
| | | | after 14 | 0.86 |
| | | | days | |
| | | | after 28 | 0.73 |
| | | | days | |
| | | | after 35 | 0.85 |
| | | | days | |
| | | | after 42 | 0.82 |
| | | | days | |
| Example 9 | 1050 | 1.2 | initial | 0.854 |
| | | | value | |
| | | | after 1 day | 0.85 |
| | | | after 7 | 0.91 |
| | | | days | |
| | | | after 14 | 0.93 |
| | | | days | |
| | | | after 28 | 0.89 |
| | | | days | |
| | | | after 35 | 0.80 |
| | | | days | |
| | | | after 42 | 0.85 |
| | | | days | |
| Example 10 | 1200 | 1.43 | initial | 0.442 |
| | | | value | |
| | | | after 1 day | 0.44 |
| | | | after 7 | 0.41 |
| | | | days | |
| | | | after 14 | 0.41 |
| | | | days | |
| | | | after 28 | 0.44 |
| | | | days | |
| | | | after 35 | 0.45 |
| | | | days | |
| | | | after 42 | 0.44 |
| | | | days | |
| Example 11 | 1500 | 1.45 | initial | 0.428 |
| | | | value | |
| | | | after 1 day | 0.43 |
| | | | after 7 | 0.36 |
| | | | days | |
| | | | after 14 | 0.32 |
| | | | days | |
| | | | after 28 | 0.36 |
| | | | days | |
| | | | after 35 | 0.35 |
| | | | days | |
| | | | after 42 | 0.4 |
| | | | days | |
| Example 12 | 1800 | 1.48 | initial | 0.384 |
| | | | value | |
| | | | after 1 day | 0.38 |
| | | | after 7 | 0.31 |
| | | | days | |
| | | | after 14 | 0.30 |
| | | | days | |
| | | | after 28 | 0.30 |
| | | | days | |
| | | | after 35 | 0.33 |
| | | | days | |
| | | | after 42 | 0.32 |
| | | | days | |
| Example 13 | 1100 | 1.42 | initial | 0.811 |
| | | | value | |
| | | | after 1 day | 0.81 |
| | | | after 7 | 0.68 |
| | | | days | |
| | | | after 14 | 0.70 |
| | | | days | |
| | | | after 28 | 0.67 |
| | | | days | |
| | | | after 35 | 0.66 |
| | | | days | |
| | | | after 42 | 0.67 |
| | | | days | |
| Example 14 | 1000 | 1.21 | initial | 1.18 |
| | | | value | |
| | | | after 1 day | 1.18 |
| | | | after 7 | 1.11 |
| | | | days | |
| | | | after 14 | 1.37 |
| | | | days | |
| | | | after 28 | 1.57 |
| | | | days | |
| | | | after 35 | 1.02 |
| | | | days | |
| | | | after 42 | 1.43 |
| | | | days | |
| Example 15 | 1300 | 1.30 | initial | 0.518 |
| | | | value | |
| | | | after 1 day | 0.52 |
| | | | after 7 | 0.44 |
| | | | days | |
| | | | after 14 | 0.54 |
| | | | days | |
| | | | after 28 | 0.49 |
| | | | days | |
| | | | after 35 | 0.55 |
| | | | days | |
| | | | after 42 | 0.53 |
| | | | days | |
| Comparative | | | initial | 0.259 |
| Example 1 | | | value | |
| (employing silver | | | after 5 | 0.157 |
| powders) | | | days | |
| | | | after 8 | 0.205 |
| | | | days | |
| | | | after 14 | 0.240 |
| | | | days | |
| | | | after 19 | 0.250 |
| | | | days | |
| Comparative | | | initial | 0.132 |
| Example 2 | | | value | |
| (employing | | | after 1 | 0.0945 |
| silver-plated copper | | | day | |
| powders) | | | after 2 | 0.977 |
| | | | days | |
| | | | after 3 | 0.114 |
| | | | days | |
| | | | after 6 | 0.180 |
| | | | days | |
| | | | after 8 | 0.242 |
| | | | days | |
| | | | after 10 | 0.243 |
| | | | days | |
| | | | after 2 | 0.723 |
| | | | days | |
| | | | after 14 | 10.9 |
| | | | days | |
| | | | after 5 | 27.0 |
| | | | days | |

In practical application, the viscosities of the thermosetting conductive coatings are required to be controlled between 400 and 800 cps, and the viscosities of the thermoplastic conductive coatings are required to be controlled in the range of 500 to 2000 cps. As can be seen from Table 18, the viscosities of the thermosetting conductive coatings obtained in Examples 1 to 8 were between 400 to 750 cps; and the viscosities of the thermoplastic conductive coatings obtained in Examples 9 to 15 were within the range of 1000 to 1800 cps, which are very suitable to form conductive coating layers in capacitors.

The density of the conductive coating is preferably less than 2.2 g/cm³. As shown in Table 18, the densities of the conductive coatings in Examples 1 to 15 were between 1.2 and 1.52 g/cm³, all of which were less than 2.2 g/cm³.

In view of the hot-wet test results, the initial volume resistivity of a conductive coating is required to be less than 0.01 Ω·cm⁻¹, and not apparently increase in the subsequent test period and maintain for at least one month.

As shown in Table 18, the initial volume resistivities of the conductive coatings in Examples 1 to 15 were between 0.428×10⁻³ to 4.5×10⁻³ Ω·cm⁻¹, all of which were less than 0.01 Ω·cm⁻¹, and these resitivities did not apparently increase in the subsequent test period and maintain for 42 days, exhibiting excellent hot-wet resistances.

The conductive coating employing silver powders (Comparative Example 1) and the conductive coating employing silver-plated copper powders (Comparative Example 2) are also listed in Table 18. It can be seen that the conductivity properties of the conductive coatings according to the present invention is close to those of the conductive coating employing silver powders, while the conductive coating employing silver-plated copper powders showed evidently inferior hot stability and the volume resistivity increased by more than 100 times after 15 days.

The embodiments described above are intended to illustrate the present invention and should not be construed as restricting the invention set forth in the appended claims or reducing the scope thereof. The foregoing embodiments are not limitative in construction but can of course be modified within the technical scope of the claims.

What is claimed is:

1. A conductive coating for capacitors, comprising:
5 to 30 wt % of an epoxy resin;
0.5 to 5 wt % of a curing agent for the epoxy resin;
20 to 50 wt % of nonmetallic silver-plated particles; and
40 to 70 wt % of a solvent.

2. The conductive coating according to claim 1, wherein the epoxy resin is a biphenol based epoxy resin or novolac based epoxy resin.

3. The conductive coating according to claim 2, wherein the epoxy resin is a biphenol A based epoxy resin.

4. The conductive coating according to claim 1, wherein the curing agent is an amine based curing agent or an imidazole based curing agent.

5. The conductive coating according to claim 4, wherein the curing agent is triethanolamine.

6. The conductive coating according to claim 1, wherein the nonmetallic silver-plated particles satisfy at least one of the following conditions:
a density is 3 to 5 g/cm³,
an average particles size is 5 to 100 μm, and
an amount of plated silver of 20 to 60 wt %, based on the total amount of the nonmetallic silver-plated particles.

7. The conductive coating according to claim 1, wherein the nonmetallic material of the nonmetallic silver-plated particles is one or more selected from glass, boron nitride, calcium carbonate, carbon black, carbon fiber, alumina and polymer materials.

8. The conductive coating according to claim 7, wherein the nonmetallic silver-plated particles are silver-plated glass particles or silver-plated boron nitride particles.

9. The conductive coating according to claim 8, wherein the nonmetallic silver-plated particles are silver-plated glass particles, and the conductive silver coating additionally comprises an ion exchanger.

10. The conductive coating according to claim 9, wherein the solvent is one or more solvent selected from ethylene glycol butyl ether acetate, dipropylene glycol monomethyl ether, and ethylene glycol monobutyl ether.

11. The conductive coating according to claim 1, additionally comprising one or more of the following additives: adhesion promoters, dispersants, defoamers, and thixotropic adjusters.

12. The conductive coating according to claim 1, wherein the viscosity (25° C.) of the coating is 400 to 800 mPa·s.

13. A condensate of the conductive coating according to claim 1, wherein the solvent content of the condensate is less than the solvent content of the conductive coating.

14. The condensate of the conductive coating according to claim 13, wherein the viscosity (25° C.) of the condensate is 3000 to 30000 cps.

15. A conductive coating for capacitors, comprising:
3 to 20 wt % of a thermoplastic resin;
20 to 50 wt % of nonmetallic silver-plated particles; and
40 to 70 wt % of a solvent;
wherein the thermoplastic resin is a fluorine rubber.

16. The conductive coating according to claim 15, wherein the fluorine rubber is selected from fluorine rubber elastomers and block copolymers of fluoroethylene monomers.

17. The conductive coating according to claim 15, wherein the nonmetallic silver-plated particles satisfy at least one of the following conditions:
a density is 3 to 5 g/cm³,
an average particles size is 5 to 100 μm, and
an amount of plated silver of 20 to 60 wt %, based on the total amount of the nonmetallic silver-plated particles.

18. The conductive coating according to claim 15, wherein the nonmetallic material of the nonmetallic silver-plated particles is one or more selected from glass, boron nitride, calcium carbonate, carbon black, carbon fiber, alumina and polymer materials.

19. The conductive coating according to claim 18, wherein the nonmetallic silver-plated particles are silver-plated glass particles or silver-plated boron nitride particles.

20. The conductive coating according to claim 19, wherein the nonmetallic silver-plated particles are silver-plated glass particles, and the conductive silver coating additionally comprises an ion exchanger.

21. The conductive coating according to claim 15, wherein the solvent is one or more solvent selected from ethylene glycol butyl ether acetate, dipropylene glycol monomethyl ether, and ethylene glycol monobutyl ether.

22. The conductive coating according to claim 15, additionally comprising one or more of the following additives: adhesion promoters, dispersants, defoamers, and thixotropic adjusters.
